(19) United States
(12) Patent Application Publication
(10) Pub. No.: US 2021/0045354 A1
(43) Pub. Date: Feb. 18, 2021

(54) Animal Restraint Assembly

(71) Applicants: John Sievewright, Howell, MI (US); Elizabeth Sievewright, Howell, MI (US)

(72) Inventors: John Sievewright, Howell, MI (US); Elizabeth Sievewright, Howell, MI (US)

(21) Appl. No.: 16/538,959

(22) Filed: Aug. 13, 2019

(51) Int. Cl. A01K 15/04; A01K 27/00

(52) U.S. Cl. CPC A01K 15/04; A01K 27/006

(57) ABSTRACT

An animal restraint assembly includes a mount that insertably receives an animal collar. A housing is coupled to the mount thereby facilitating the housing to be suspended from the animal collar. A pair of extensions is each slidably coupled to the housing. Each of the extensions is extendable a pre-determined distance outwardly from the housing for adjusting an overall width of the extensions and the housing. Moreover, each of the extensions abuts surfaces on either side of a passage which has a width that is less that the overall width of the extensions and the housing. In this way the extensions inhibit an animal wearing the animal collar from being able to pass through the passage.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to restraint device and more particularly pertains to a new restraint device for inhibiting an animal from passing through a narrow passage.

### (2) Description of Related Art Including Information Disclosed Under 37 CFR 1.97 and 1.98

The prior art relates to restraint devices.

### BRIEF SUMMARY OF THE INVENTION

An embodiment of the disclosure meets the needs presented above by generally comprising a mount that insertably receives an animal collar. A housing is coupled to the mount thereby facilitating the housing to be suspended from the animal collar. A pair of extensions is each slidably coupled to the housing. Each of the extensions is extendable a pre-determined distance outwardly from the housing for adjusting an overall width of the extensions and the housing. Moreover, each of the extensions abuts surfaces on either side of a passage which has a width that is less that the overall width of the extensions and the housing. In this way the extensions inhibit an animal wearing the animal collar from being able to pass through the passage.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an animal restraint assembly according to an embodiment of the disclosure.

FIG. 2 is a back phantom view of an embodiment of the disclosure.

FIG. 3 is a right side view of an embodiment of the disclosure.

FIG. 4 is a top view of an embodiment of the disclosure.

FIG. 5 is a bottom view of an embodiment of the disclosure.

FIG. 6 is a front phantom view of an embodiment of the disclosure.

FIG. 7 is a perspective view of a pair of extensions of an embodiment of the disclosure.

FIG. 8 is a perspective in-use view of an embodiment of the disclosure.

### DETAILED DESCRIPTION OF THE INVENTION

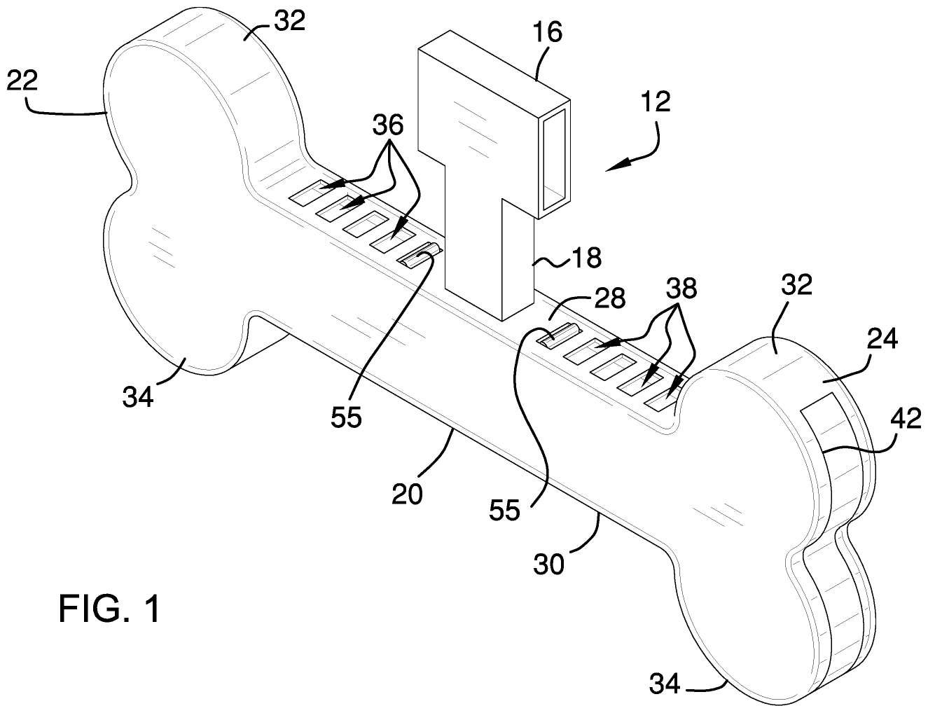

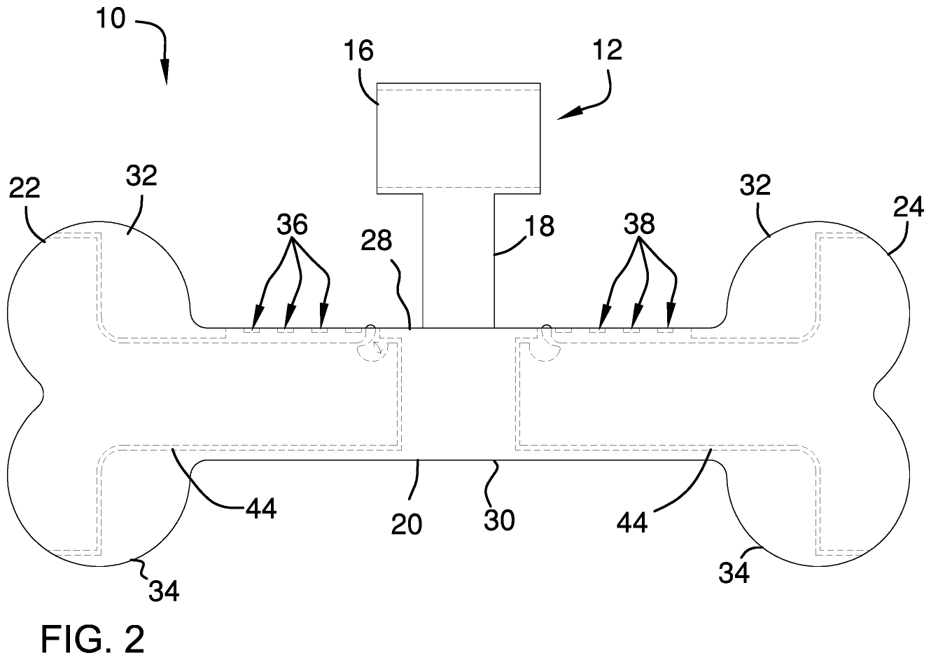

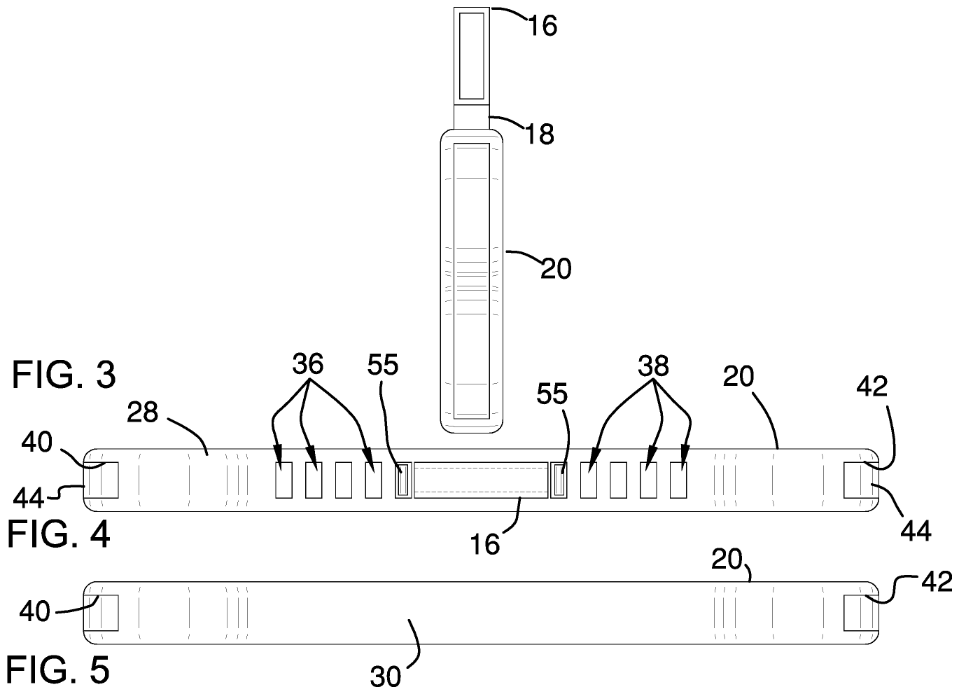

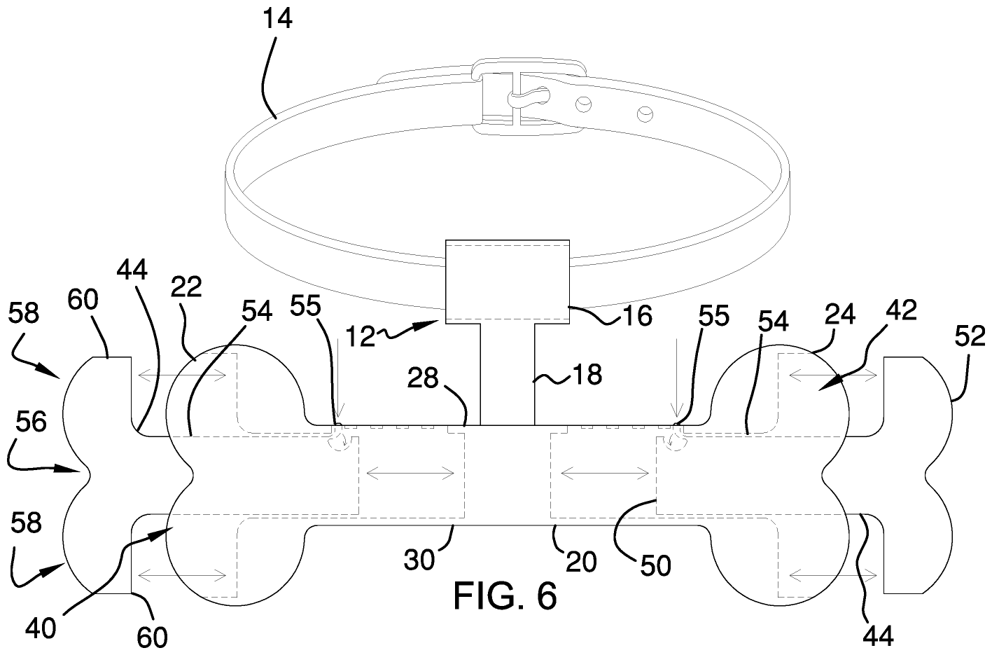

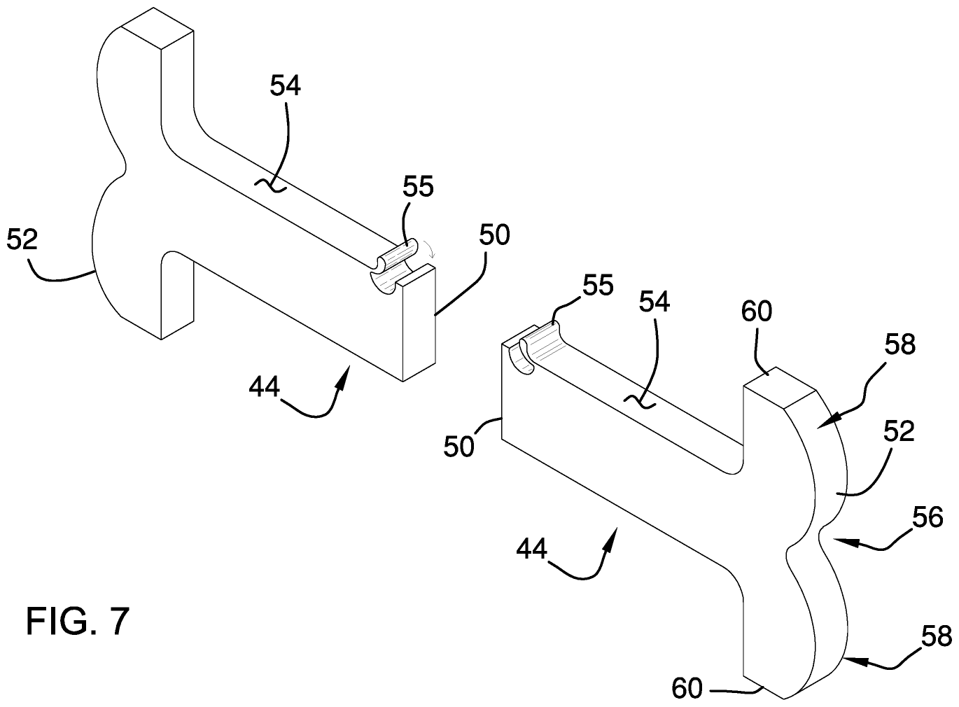

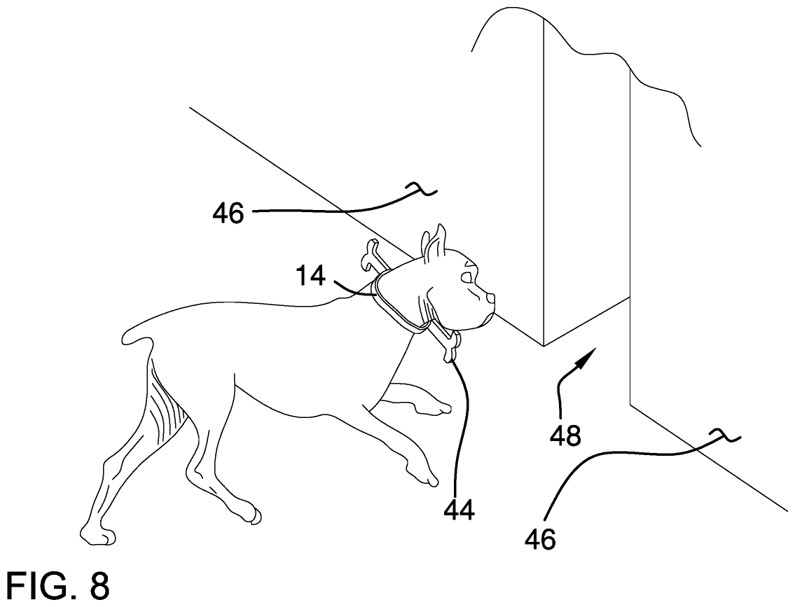

With reference now to the drawings, and in particular to FIGS. 1 through 8 thereof, a new restraint device embodying the principles and concepts of an embodiment of the disclosure and generally designated by the reference numeral 10 will be described.

As best illustrated in FIGS. 1 through 8, the animal restraint assembly 10 generally comprises a mount 12 that insertably receives an animal collar 14. The mount 12 has a sleeve 16 and a stem 18 extending downwardly from the sleeve 16. The animal collar 14, which may be a dog collar or the like, is extended through the sleeve 16 having the stem 18 extending downwardly from the animal collar 14. In this way the mount 12 is retained on an animal when the animal wears the animal collar 14.

A housing 20 is coupled to the mount 12 thereby facilitating the housing 20 to be suspended from the animal collar 14. The housing 20 has a first end 22, a second end 24 and an outer wall 26 extending therebetween, and the outer wall 26 has a top side 28 and a bottom side 30. The top side 28 curves upwardly from a centerline of the housing 20 to define a pair of top lobes 32 on the top side 28. Each of the top lobes 32 is aligned with a respective one of the first end 22 and the second end 24. The bottom side 30 curves downwardly from the centerline of the housing 20 to define a pair of bottom lobes 34 on the bottom side 30. Each of the bottom lobes 34 is aligned with a respective one of the first end 22 and the second end 24 and each of the top lobes 32 and the bottom lobes 34 gives the housing 20 the ornamental appearance of a bone for a dog.

The stem 18 of the mount 12 is coupled to the top side 28 having the sleeve 16 of the mount 12 being spaced from the top side 28. The stem 18 is centrally positioned between the first end 22 and the second end 24. The housing 20 is hollow and the top side 28 has a plurality of first openings 36 each extending into an interior of the housing 20. The first openings 36 are spaced apart from each other and are distributed between the stem 18 and the first end 22. The top side 28 has a plurality of second openings 38 each extending into the interior of the housing 20. The second openings 38 are spaced apart from each other and are distributed between the stem 18 and the second end 24. The first end 22 has a first hole 40 extending into the interior of the housing 20 and the second end 24 has a second hole 42 extending into the interior of the housing 20.

A pair of extensions 44 is provided and each of the extensions 44 is slidably coupled to the housing 20. Each of the extensions 44 is extendable a pre-determined distance outwardly from the housing 20 for adjusting an overall width of the extensions 44 and the housing 20. Each of the extensions 44 abuts surfaces 46 on either side of a passage 48 which has a width that is less that the overall width of the extensions 44 and the housing 20. In this way the extensions 44 inhibit the animal wearing the animal collar 14 from being able to pass through the passage 48. The passage 48 may be the spaces between slats in a fence, a gap between buildings, or any other space through which a domesticated animal might pass.

Each of the extensions 44 has a primary end 50, a secondary end 52 and an upper surface 54 extending therebetween. Each of the extensions 44 has an engagement 55 that is movably positioned on the upper surface 54. The engagement 55 on each of the extensions 44 is positioned adjacent to the secondary end 52 of the extensions 44. The engagement 55 on each of the extensions 44 is biased to extend upwardly from the upper surface 54, and the engagement 55 can be urged toward the upper surface 54. The secondary end 52 of each of the extensions 44 is undulated to define a depression 56 between a pair of hills 58 on the secondary end 52 of each of the extensions 44. In this way the secondary end 52 of each of the extensions 44 conforms to the profile of a respective one of the first end 22 and the second end 24 of the housing 20 when the extensions 44 are fully retracted into the housing 20.

Each of the extensions 44 has a pair of horns 60 that each extends in opposite directions from the extension. Each of the horns 60 is aligned with the secondary end 52 of a respective one of the extensions 44. Each of the extensions 44 is inserted into a respective one of the first hole 40 and the second hole 42 in the housing 20. Moreover, the engagement 55 on each of the extensions 44 engages respective ones of the first openings 36 and the second openings 38 in the housing 20. In this way each of the extensions 44 is retained to extend the pre-determined distance outwardly from the housing 20. The engagement 55 on each of the extensions 44 is depressed for adjusting the extensions 44.

In use, the animal collar 14 is extended through the sleeve 16 before the animal collar 14 is placed on the animal. In this way the housing 20 and the extensions 44 are suspended beneath the animal's neck. Moreover, the housing 20 and the extensions 44 are oriented to extend out from each side of the animal. Each of the extensions 44 is pulled out of the housing 20 a distance sufficient to give the extensions 44 and the housing 20 an overall width that is greater than a passage 48 to which the animal has access. Thus, the extensions 44 and the housing 20 inhibit the animal from passing through the passage 48.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An animal restraint assembly being configured to inhibit an animal from passing through a space of a predetermined width, said assembly comprising:
a mount insertably receiving an animal collar;
a housing being coupled to said mount thereby facilitating said housing to be suspended from the animal collar; and
a pair of extensions, each of said extensions being slidably coupled to said housing, each of said extensions being extendable a pre-determined distance outwardly from said housing for adjusting an overall width of said extensions and said housing, each of said extensions abutting surfaces on either side of a passage having a width being less that the overall width of said extensions and said housing wherein said extensions are configured to inhibit an animal wearing said animal collar from being able to pass through the passage.

2. The assembly according to claim 1, wherein said mount has a sleeve and a stem extending downwardly from said sleeve, said sleeve having the animal collar being extended therethrough having said stem extending downwardly from the animal collar.

3. The assembly according to claim 2, wherein said housing has a first end, a second end and an outer wall extending therebetween, said outer wall having a top side and a bottom side, said top side curving upwardly from a centerline of said housing to define a pair of top lobes on said top side, each of said top lobes being aligned with a respective one of said first end and said second end, said bottom side curving downwardly from said centerline of said housing to define a pair of bottom lobes on said bottom side, each of said bottom lobes being aligned with a respective one of said first end and said second end, each of said top lobes and said bottom lobes giving said housing the ornamental appearance of a bone for a dog.

4. The assembly according to claim 3, wherein said stem of said mount is coupled to said top side having said sleeve of said mount being spaced from said top side, said stem being centrally positioned between said first end and said second end.

5. The assembly according to claim 4, wherein said housing is hollow, said top side has a plurality of first openings each extending into an interior of said housing, said first openings being spaced apart from each other and being distributed between said stem and said first end.

6. The assembly according to claim 5, wherein said top side has a plurality of second openings each extending into said interior of said housing, said second openings being spaced apart from each other and being distributed between said stem and said second end.

7. The assembly according to claim 6, wherein:
said first end has a first hole extending into said interior of said housing; and
said second end has a second hole extending into said interior of said housing.

8. The assembly according to claim 7, wherein each of said extensions has a primary end, a secondary end and an upper surface extending therebetween, each of said extensions having an engagement being movably positioned on said upper surface, said engagement on each of said extensions being positioned adjacent to said secondary end of said extensions.

9. The assembly according to claim 8, wherein each of said extensions has a pair of horns each extending in opposite directions from said extension, each of said horns being aligned with said secondary end of a respective one of said extensions.

10. The assembly according to claim 9, wherein said secondary end of each of said extensions is undulated to define a depression between a pair of hills on said secondary end of each of said extensions.

11. The assembly according to claim 7, wherein each of said extensions is inserted into a respective one of said first hole and said second hole in said housing, said engagement on each of said extensions engaging respective ones of said first openings and said second openings in said housing thereby facilitating each of said extensions to be extended said pre-determined distance outwardly from said housing.

12. The assembly according to claim 10, wherein said secondary end of each of said extensions conforms to the profile of a respective one of said first end and said second end of said housing when said extensions are fully retracted into said housing.

13. An animal restraint assembly being configured to inhibit an animal from passing through a space of a predetermined width, said assembly comprising:
a mount insertably receiving an animal collar, said mount having a sleeve and a stem extending downwardly from said sleeve, said sleeve having the animal collar being extended therethrough having said stem extending downwardly from the animal collar;
a housing being coupled to said mount thereby facilitating said housing to be suspended from the animal collar, said housing being hollow, said housing having a first end, a second end and an outer wall extending therebetween, said outer wall having a top side and a bottom side, said top side curving upwardly from a centerline of said housing to define a pair of top lobes on said top side, each of said top lobes being aligned with a respective one of said first end and said second end, said bottom side curving downwardly from said centerline of said housing to define a pair of bottom lobes on said bottom side, each of said bottom lobes being aligned with a respective one of said first end and said second end, each of said top lobes and said bottom lobes giving said housing the ornamental appearance of a bone for a dog, said stem of said mount being coupled to said top side having said sleeve of said mount being spaced from said top side, said stem being centrally positioned between said first end and said second end, said top side having a plurality of first openings each extending into an interior of said housing, said first openings being spaced apart from each other and being distributed between said stem and said first end, said top side having a plurality of second openings each extending into said interior of said housing, said second openings being spaced apart from each other and being distributed between said stem and said second end, said first end having a first hole extending into said interior of said housing, said second end having a second hole extending into said interior of said housing; and
a pair of extensions, each of said extensions being slidably coupled to said housing, each of said extensions being extendable a pre-determined distance outwardly from said housing for adjusting an overall width of said extensions and said housing, each of said extensions abutting surfaces on either side of a passage having a width being less that the overall width of said extensions and said housing wherein said extensions are configured to inhibit an animal wearing said animal collar from being able to pass through the passage, each of said extensions having a primary end, a secondary end and an upper surface extending therebetween, each of said extensions having an engagement being movably positioned on said upper surface, said engagement on each of said extensions being positioned adjacent to said secondary end of said extensions, each of said extensions having a pair of horns each extending in opposite directions from said extension, each of said horns being aligned with said secondary end of a respective one of said extensions, said secondary end of each of said extensions being undulated to define a depression between a pair of hills on said secondary end of each of said extensions, each of said extensions being inserted into a respective one of said first hole and said second hole in said housing, said engagement on each of said extensions engaging respective ones of said first openings and said second openings in said housing thereby facilitating each of said extensions to be extended said pre-determined distance outwardly from said housing, said secondary end of each of said extensions conforming to the profile of a respective one of said first end and said second end of said housing when said extensions are fully retracted into said housing.
